(19) United States
(12) Patent Application Publication
(10) Pub. No.: US 2016/0249587 A1
(43) Pub. Date: Sep. 1, 2016

(54) Safety Nail Clipper

(71) Applicant: Timothy A. Sobonya, Mentor, OH (US)

(72) Inventor: Timothy A. Sobonya, Mentor, OH (US)

(21) Appl. No.: 15/053,621

(22) Filed: Feb. 25, 2016

Related U.S. Application Data
(60) Provisional application No. 62/121,176, filed on Feb. 26, 2015.

(51) Int. Cl. A01K 17/00; A45D 29/02; A01K 13/00

(52) U.S. Cl. CPC A01K 17/00; A01K 13/00; A45D 29/02

(57) ABSTRACT

A safety nail clipper is a device utilized to trim a nail without damaging a blood vessel. The device features a first flex arm and a second flex arm that are attached to a first jaw and a second jaw. The first jaw and the second jaw each include a cutting slot into which a nail may be inserted for cutting. The device minimizes the length of nail that may be cut at a time by physically impeding the progress of the nail into the device. A stop plate is engaged into the first flex arm and the second flex arm adjacent to the first jaw and the second jaw in order to block the progress of the nail. The stop plate is sufficiently spaced apart from the first jaw and the second jaw to minimize the length of nail that may be cut at a time.

The current application claims a priority to the U.S. Provisional Patent application Ser. No. 62/121,176 filed on Feb. 26, 2015.

### FIELD OF THE INVENTION

The present invention relates generally to a nail clipper. More specifically, the present invention is a safety nail clipper that minimizes the length of nail that is clipped in order to avoid cutting or otherwise damaging a blood vessel.

### BACKGROUND OF THE INVENTION

One of the most important aspects of pet care for domestic animals such as dogs is the maintenance of the pet's nails. In a natural outdoor environment, nails are typically worn down naturally due to activities such as running, climbing, and digging. However, domestic animals who spend large amounts of time indoors are generally not afforded the same opportunities for physical activity. One of the consequences of a primarily indoor lifestyle is an animal's nails becoming long. Long nails are not only a cosmetic issue for an animal and can negatively affect the animal's posture and gait if left unchecked. Over time, improper nail care can result in chronic discomfort and the possibility of injury. Trimming a pet's nails can be a difficult task due to the fact that the pet may become scared when the owner attempts to trim the nails. Trimming nails is additionally a challenging task due to the fact that it can be difficult to determine when exactly to stop trimming a nail in order to avoid reaching a blood vessel. Conventional nail clippers generally do not include a means of identifying a blood vessel although more advanced nail clippers include a light source or similar means of aiding in visually identifying a blood vessel when trimming a nail. However, these nail clippers typically require a battery or similar power source in order to function.

The present invention is a safety nail clipper that prevents damage to a blood vessel while trimming a nail. The present invention minimizes the length of nail that may be clipped. This is accomplished by physically blocking the progress of the nail into the clipper in order to ensure that only a small portion of the nail is cut at a time.

### BRIEF DESCRIPTION OF THE DRAWINGS

FIG. 1 is a top perspective view of the present invention.

FIG. 2 is a bottom perspective view of the present invention.

FIG. 3 is a front view of the present invention.

FIG. 4 is a cross-sectional view of the present invention taken along line A-A of FIG. 3.

FIG. 5 is a top perspective view of the present invention with the stop plate removed from the first flex arm and the second flex arm.

FIG. 6 is a top perspective view of the present invention with the casing.

FIG. 7 is a front view of the present invention with the casing.

FIG. 8 is a cross-sectional view of the present invention with the casing taken along line B-B of FIG. 7.

FIG. 9 is a rear perspective view of the present invention with the casing.

FIG. 10 is a top perspective view of the present invention with the grip positioned on the second flex arm.

### DETAIL DESCRIPTIONS OF THE INVENTION

All illustrations of the drawings are for the purpose of describing selected versions of the present invention and are not intended to limit the scope of the present invention.

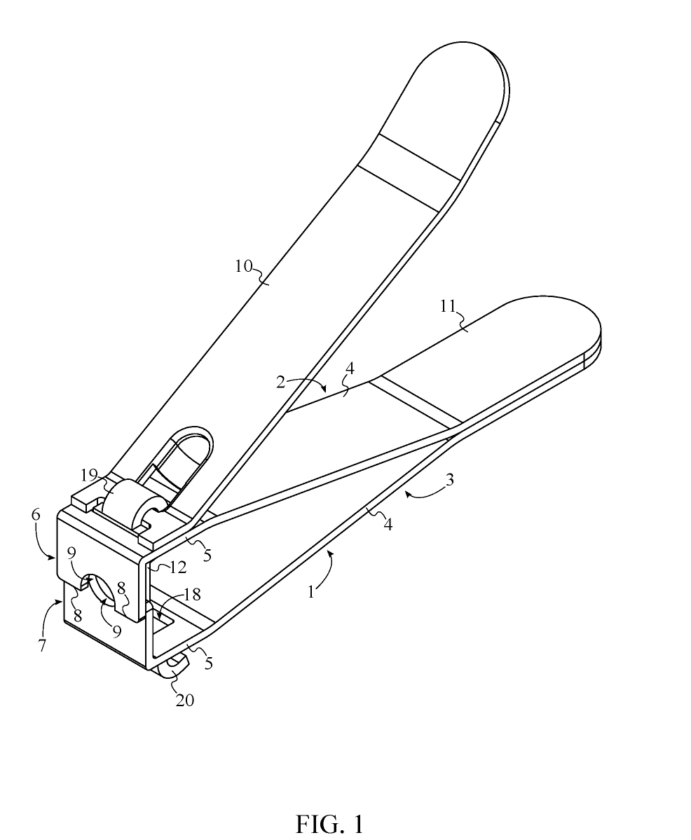

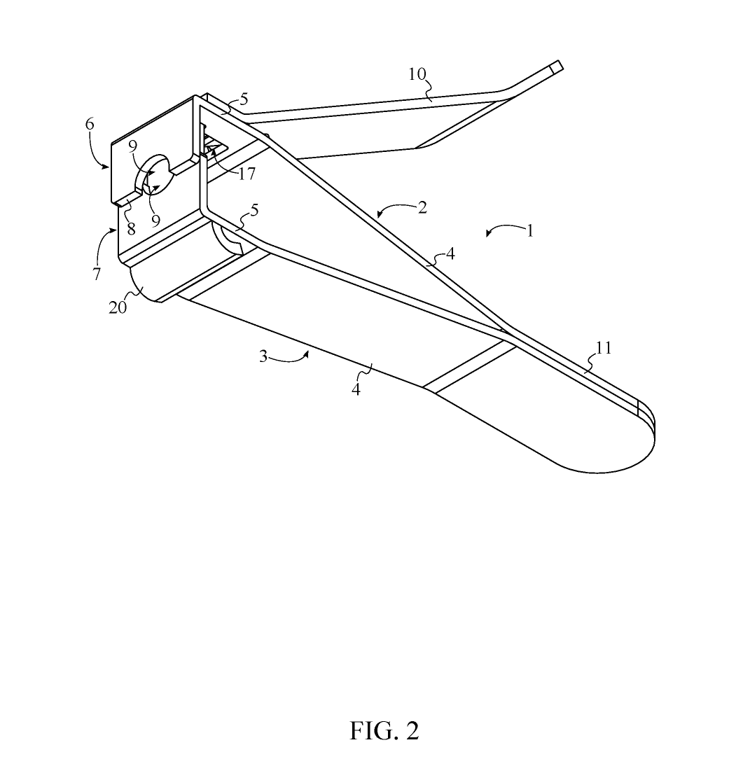

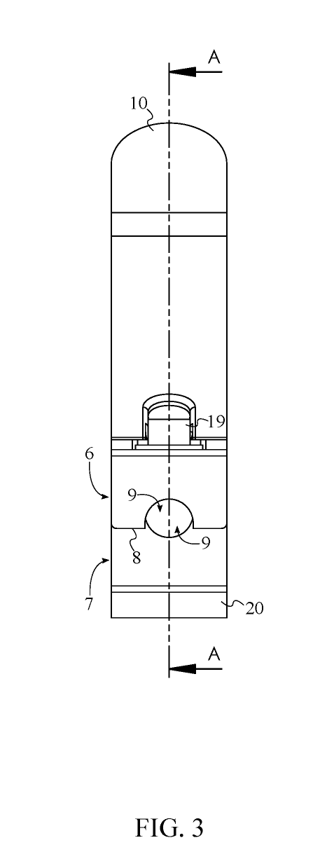

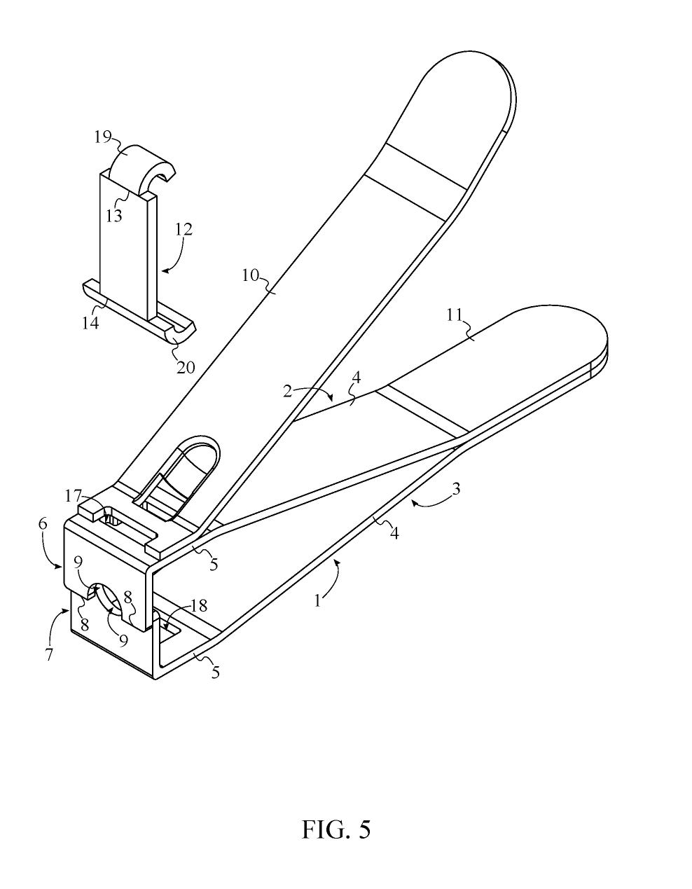

The present invention is a safety nail clipper that minimizes the length of nail that is clipped in order to prevent damage to a blood vessel. The present invention is primarily intended for use with domestic animals such as dogs. However, the present invention may be utilized to trim the nails of other types of animals in addition to dogs as well. The present invention is shown in FIGS. 1-5 and comprises a clipper assembly 1, a push handle 10, a grasping handle 11, and a stop plate 12.

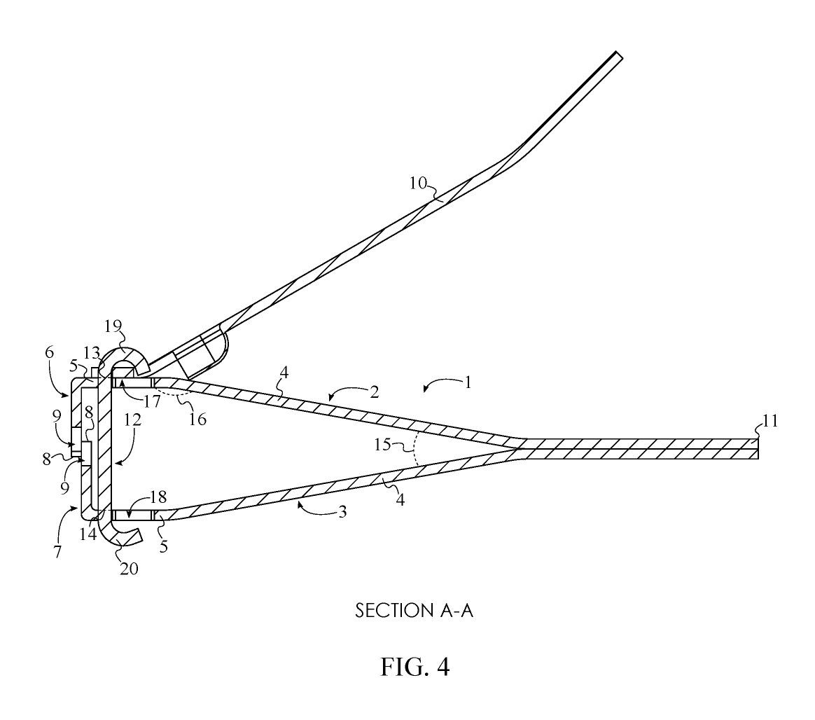

The clipper assembly 1 is the device that is utilized to physically trim a nail. The clipper assembly 1 comprises a first flex arm 2, a second flex arm 3, a first jaw 6, and a second jaw 7. When a nail is trimmed, the first flex arm 2 and the second flex arm 3 are able to bend, thus moving the first jaw 6 relative to the second jaw 7 to trim the nail. The grasping handle 11 is held by the user during use of the present invention when the push handle 10 is actuated to trim a nail. The first flex arm 2 and the second flex arm 3 are connected to the grasping handle 11, enabling the grasping handle 11 to provide structural support to the first flex arm 2 and the second flex arm 3. As shown in FIG. 4, in the preferred embodiment of the present invention, the second flex arm 3 is oriented relative to the first flex arm 2 at an acute angle 15. The first flex arm 2 and the second flex arm 3 are thus approximately mirrored to each other across the grasping handle 11. The first jaw 6 is connected to the first flex arm 2, opposite to the grasping handle 11 along the first flex arm 2. Similarly, the second jaw 7 is connected to the second flex arm 3, opposite to the grasping handle 11 along the second flex arm 3. The first jaw 6 is thus moved along with the first flex arm 2 relative to the second jaw 7 when the push handle 10 is actuated to trim a nail. The first flex arm 2 is preferably positioned in between the push handle 10 and the second flex arm 3. The first flex arm 2 is thus pressed by the push handle 10 when the push handle 10 is actuated during the trimming of a nail.

With continued reference to FIGS. 1-5, the first jaw 6 and the second jaw 7 each comprise a cutting edge 8 and a cutting slot 9. The cutting edge 8 is the edge that comes into contact with a nail during nail trimming while the cutting slot 9 provides clearance for the nail when the nail is inserted. The cutting edge 8 of the first jaw 6 is positioned adjacent to the cutting edge 8 of the second jaw 7, in between the first flex arm 2 and the second flex arm 3. The first jaw 6 is thus able to trim a nail in conjunction with the second jaw 7. The cutting slot 9 traverses into the first jaw 6 and the second jaw 7 from the cutting edge 8. The cutting slot 9 of the first jaw 6 and the cutting slot 9 of the second jaw 7 thus form an opening into which a nail may be inserted. The push handle 10 is hingedly coupled to the first flex arm 2 through the stop plate 12. The stop plate 12 prevents the push handle 10 from separating from the first flex arm 2. The push handle 10 is able to flexibly press against the first flex arm 2 when the push handle 10 is actuated. The first jaw 6 is slidably positioned against the second jaw 7, allowing the first jaw 6 to slide against the second jaw 7, trimming the nail inserted within the cutting slot 9 of the first jaw 6 and the cutting slot 9 of the second jaw 7. Because the present invention is primarily intended for use with domestic animals, in the preferred embodiment of the present invention, the cutting slot 9 is semicircular to accommodate the circular cross-section of the nails of various domestic animals such as dogs. The positioning of the first jaw 6 and the second jaw 7 is such that the cutting slot 9 of the first jaw 6 and the cutting slot 9 of the second jaw 7 form a circular opening for a nail.

The first flex arm 2 and the second flex arm 3 each comprise a medial portion 4 and a cutting portion 5. The medial portion 4 is the segment of the first flex arm 2 and the second flex arm 3 that is connected to the grasping handle 11. The cutting portion 5 is the segment of the first flex arm 2 and the second flex arm 3 that is positioned adjacent to the first jaw 6 and second jaw 7. As shown in FIG. 4, the medial portion 4 is oriented relative to the cutting portion 5 at an obtuse angle 16. In the preferred embodiment of the present invention, the cutting portion 5 is oriented parallel to the grasping handle 11 and is offset from the grasping handle 11 by the medial portion 4. The first jaw 6 is perpendicularly connected to the cutting portion 5 of the first flex arm 2 while the second jaw 7 is perpendicularly connected to the cutting portion 5 of the second flex arm 3. Additionally, the first jaw 6 and the second jaw 7 are oriented perpendicular to the grasping handle 11. The first jaw 6 and the second jaw 7 are thus oriented parallel to each other, allowing the first jaw 6 to slide against the second jaw 7 when trimming a nail.

The stop plate 12 serves as a physical barrier that prevents a nail from being inserted too far within the cutting slot 9 of the first jaw 6 and the cutting slot 9 of the second jaw 7. The stop plate 12 blocks the progress of the nail into the clipper assembly 1 in order to minimize the length of nail that may be trimmed. The stop plate 12 is engaged into the first flex arm 2 and the second flex arm 3, offset from the first jaw 6 and the second jaw 7 as shown in FIG. 4. In the preferred embodiment of the present invention, the stop plate 12 is positioned at a distance of approximately two millimeters from the first jaw 6 and the second jaw 7.

With continued reference to FIGS. 1-5, the present invention further comprises a first plate retention slot 17, a second plate retention slot 18, a first retention nub 19, and a second retention nub 20. The first plate retention slot 17 and the second plate retention slot 18 ensure that the stop plate 12 remains engaged into the first flex arm 2 and the second flex arm 3. The first retention nub 19 and the second retention nub 20 aid in preventing the stop plate 12 from becoming dislodged from the first plate retention slot 17 and the second plate retention slot 18. The first plate retention slot 17 traverses normally through the first flex arm 2, adjacent to the first jaw 6. Similarly, the second plate retention slot 18 traverses normally through the second flex arm 3, adjacent to the second jaw 7. The first plate retention slot 17 and the second plate retention slot 18 thus form a channel into which the stop plate 12 may be positioned. The stop plate 12 is engaged into the first plate retention slot 17 and the second plate retention slot 18 in order to minimize the length of nail that may be inserted into the clipper assembly 1. The first plate retention slot 17 and the second plate retention slot 18 are aligned with each other, ensuring that the stop plate 12 is oriented parallel to the first jaw 6 and the second jaw 7. The first retention nub 19 is connected to a first end 13 of the stop plate 12 and is positioned in a manner such that the first retention nub 19 is able to hold the first end 13 in place against the cutting portion 5 of the first flex arm 2. Similarly, the second retention nub 20 is connected to a second end 14 of the stop plate 12, allowing the second retention nub 20 to hold the second end 14 in place against the cutting portion 5 of the second flex arm 3. The first flex arm 2 and the second flex arm 3 are thus positioned in between the first retention nub 19 and the second retention nub 20. The first retention nub 19 and the second retention nub 20 are able to provide stability for the stop plate 12 when the stop plate 12 is engaged into the first flex arm 2 and the second flex arm 3.

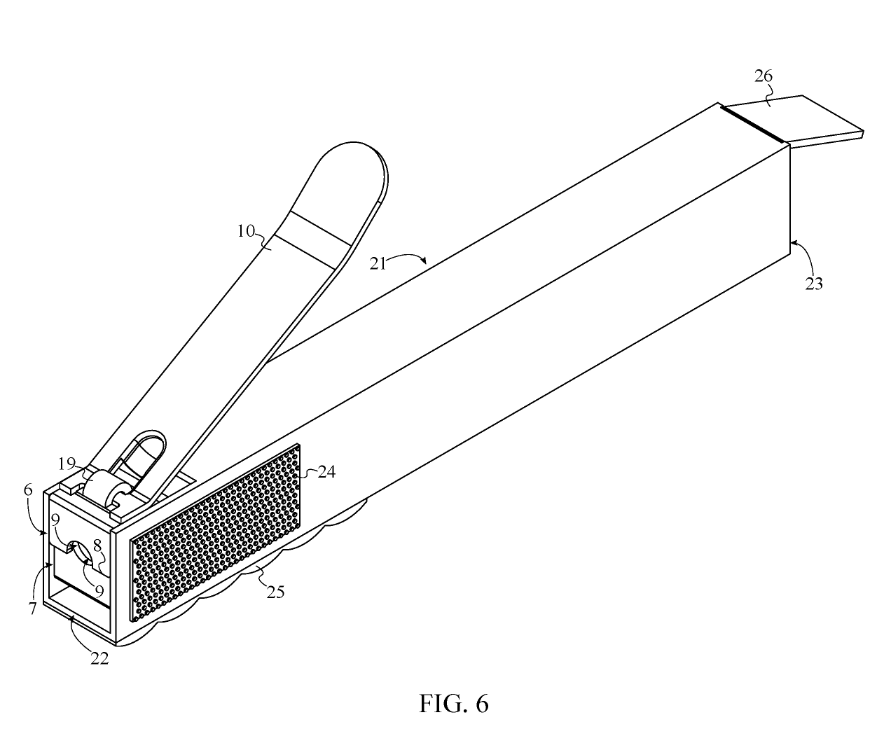

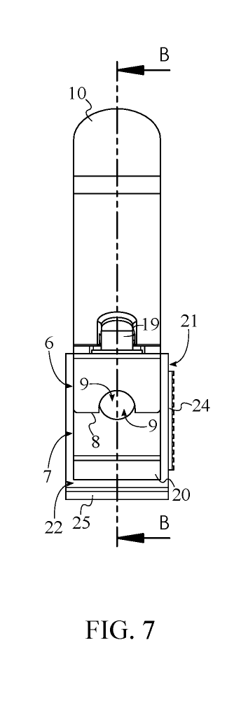

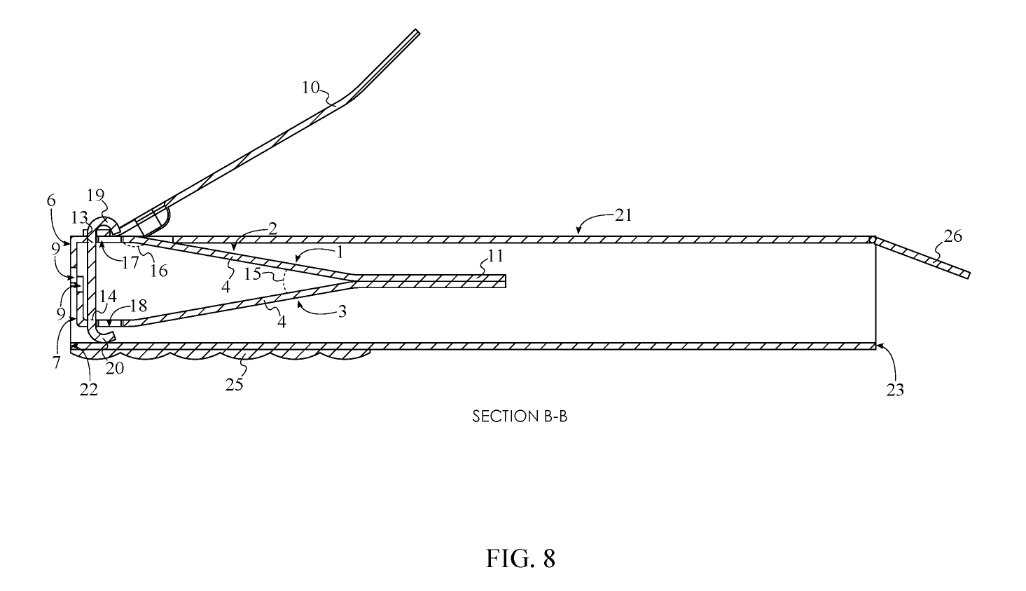

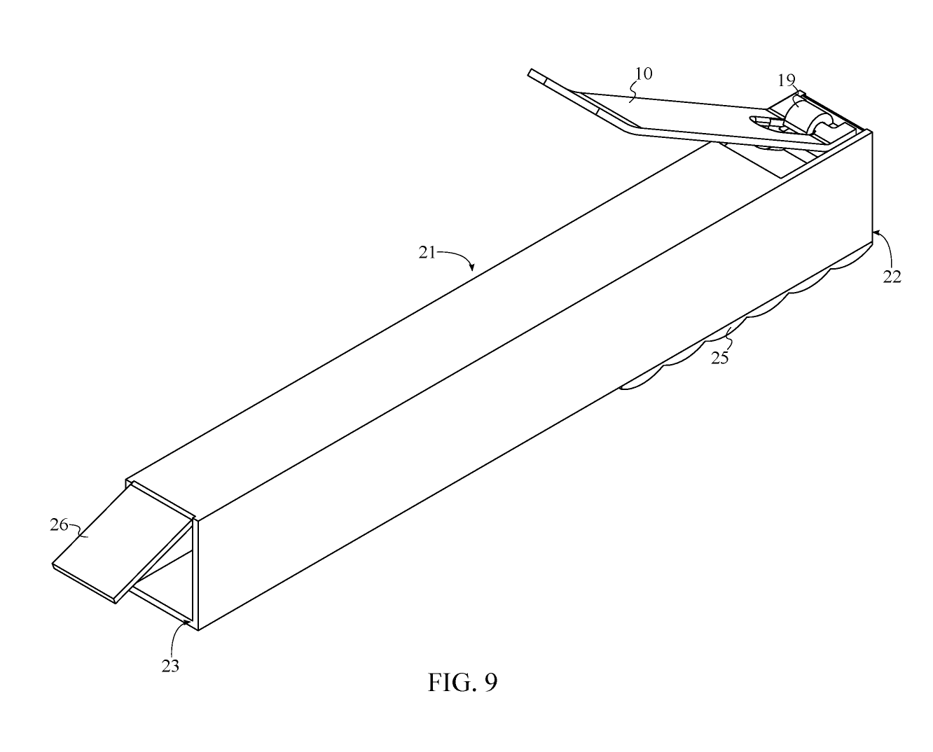

As shown in FIGS. 6-9, the present invention may further comprise a casing 21. In this embodiment of the present invention, the casing 21 is a housing structure. The casing 21 comprises a forward end 22 and an open end 23. The forward end 22 is the end of the casing 21 into which a nail is inserted for trimming. As such, the first jaw 6 and the second jaw 7 are positioned adjacent to the forward end 22. The open end 23 provides accessibility to the interior of the casing 21 and allows the user to store miscellaneous items such as cotton balls and cotton swabs within the casing 21. The clipper assembly 1 is positioned within the casing 21, allowing the casing 21 to fully enclose the components of the clipper assembly 1. However, the push handle 10 is externally positioned to the casing 21 for accessibility by the user when trimming a nail. During use of this embodiment of the present invention, the casing 21 is held by the user in lieu of the grasping handle 11. This embodiment of the present invention may further comprise a cover plate 26. The cover plate 26 is utilized to cover the open end 23 and prevent items within the casing 21 from falling out. The cover plate 26 is hingedly mounted to the casing 21, adjacent to the open end 23. As such, the cover plate 26 may be easily moved to open and close the casing 21 as needed.

With continued reference to FIGS. 6-9, the present invention may further comprise a nail file plate 24. The nail file plate 24 may be utilized to smooth and shape a nail. The nail file plate 24 is externally mounted to the casing 21 to facilitate accessibility. This embodiment of the present invention may further comprise a grip 25. The grip 25 increases the user's leverage on the casing 21 when the user holds the casing 21 while trimming a nail. The grip 25 is externally mounted to the casing 21, opposite to the push handle 10. The push handle 10 and the grip 25 are thus positioned in a manner such that the user's thumb is able to actuate the push handle 10 while the user's remaining fingers hold the casing 21 via the grip 25.

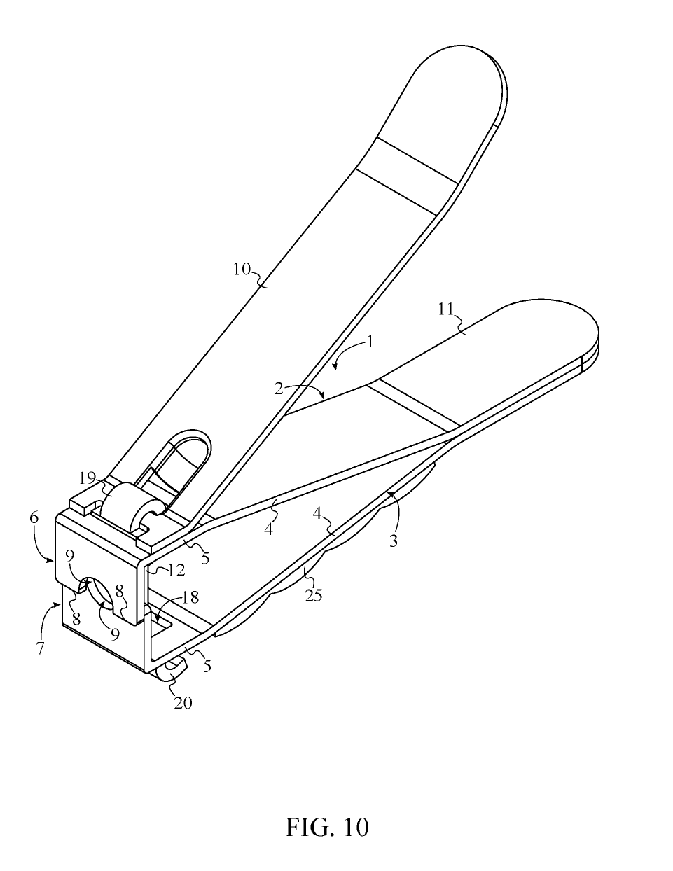

With reference to FIG. 10, in an embodiment of the present invention without the casing 21, the grip 25 is positioned on the second flex arm 3, opposite to the push handle 10. The user may thus hold the grasping handle 11 as well as the portion of the second flex arm 3 on which the grip 25 is located in order to increase leverage.

Although the present invention has been explained in relation to its preferred embodiment, it is understood that many other possible modifications and variations can be made without departing from the spirit and scope of the present invention as hereinafter claimed.

What is claimed is:

1. A safety nail clipper comprises:
a clipper assembly;
a push handle;
a grasping handle;
a stop plate;
the clipper assembly comprises a first flex arm, a second flex arm, a first jaw, and a second jaw;
the first jaw and the second jaw each comprise a cutting edge and a cutting slot;
the first flex arm and the second flex arm being connected to the grasping handle;
the cutting edge of the first jaw being positioned adjacent to the cutting edge of the second jaw, in between the first flex arm and the second flex arm;
the cutting slot traversing into the first jaw and the second jaw from the cutting edge;
the first jaw being connected to the first flex arm, opposite to the grasping handle along the first flex arm;
the second jaw being connected to the second flex arm, opposite to the grasping handle along the second flex arm;
the stop plate being engaged into the first flex arm and the second flex arm, offset from the first jaw and the second jaw;
the push handle being hingedly coupled to the first flex arm through the stop plate; and
the first jaw being slidably positioned against the second jaw.

2. The safety nail clipper as claimed in claim 1 further comprises:
the second flex arm being oriented relative to the first flex arm at an acute angle; and
the first flex arm being positioned in between the push handle and the second flex arm.

3. The safety nail clipper as claimed in claim 1 further comprises:
the first flex arm and the second flex arm each comprise a medial portion and a cutting portion;
the medial portion being oriented relative to the cutting portion at an obtuse angle;
the first jaw being perpendicularly connected to the cutting portion of the first flex arm; and
the second jaw being perpendicularly connected to the cutting portion of the second flex arm.

4. The safety nail clipper as claimed in claim 1 further comprises:
the first jaw and the second jaw being oriented perpendicular to the grasping handle.

5. The safety nail clipper as claimed in claim 1 further comprises:
a first plate retention slot;
a second plate retention slot;
a first retention nub;
a second retention nub;
the first plate retention slot traversing normally through the first flex arm, adjacent to the first jaw;
the second plate retention slot traversing normally through the second flex arm, adjacent to the second jaw;
the first retention nub being connected to a first end of the stop plate;
the second retention nub being connected to a second end of the stop plate;
the stop plate being engaged into the first plate retention slot and the second plate retention slot; and
the first flex arm and the second flex arm being positioned in between the first retention nub and the second retention nub.

6. The safety nail clipper as claimed in claim 1, wherein the cutting slot is semicircular.

7. The safety nail clipper as claimed in claim 1 further comprises:
a casing;
the casing comprises a forward end and an open end;
the clipper assembly being positioned within the casing; and
the first jaw and the second jaw being positioned adjacent to the forward end.

8. The safety nail clipper as claimed in claim 7 further comprises:
a nail file plate; and
the nail file plate being externally mounted to the casing.

9. The safety nail clipper as claimed in claim 7 further comprises:
a grip; and
the grip being externally mounted to the casing, opposite to the push handle.

10. The safety nail clipper as claimed in claim 1 further comprises:
a grip; and
the grip being positioned on the second flex arm, opposite to the push handle.

11. The safety nail clipper as claimed in claim 7 further comprises:
a cover plate; and
the cover plate being hingedly mounted to the casing, adjacent to the open end.

12. A safety nail clipper comprises:
a clipper assembly;
a push handle;
a grasping handle;
a stop plate;
a grip;
the clipper assembly comprises a first flex arm, a second flex arm, a first jaw, and a second jaw;
the first jaw and the second jaw each comprise a cutting edge and a cutting slot;
the first flex arm and the second flex arm being connected to the grasping handle;
the cutting edge of the first jaw being positioned adjacent to the cutting edge of the second jaw, in between the first flex arm and the second flex arm;
the cutting slot traversing into the first jaw and the second jaw from the cutting edge;
the first jaw being connected to the first flex arm, opposite to the grasping handle along the first flex arm;
the second jaw being connected to the second flex arm, opposite to the grasping handle along the second flex arm;
the stop plate being engaged into the first flex arm and the second flex arm, offset from the first jaw and the second jaw;
the push handle being hingedly coupled to the first flex arm through the stop plate;
the first jaw being slidably positioned against the second jaw; and
the grip being positioned on the second flex arm, opposite to the push handle.

13. The safety nail clipper as claimed in claim 12 further comprises:
the first flex arm and the second flex arm each comprise a medial portion and a cutting portion;
the second flex arm being oriented relative to the first flex arm at an acute angle;
the first flex arm being positioned in between the push handle and the second flex arm;
the medial portion being oriented relative to the cutting portion at an obtuse angle;
the first jaw being perpendicularly connected to the cutting portion of the first flex arm; and
the second jaw being perpendicularly connected to the cutting portion of the second flex arm.

14. The safety nail clipper as claimed in claim 12 further comprises:
the first jaw and the second jaw being oriented perpendicular to the grasping handle.

15. The safety nail clipper as claimed in claim 12 further comprises:
a first plate retention slot;
a second plate retention slot;
a first retention nub;
a second retention nub;
the first plate retention slot traversing normally through the first flex arm, adjacent to the first jaw;
the second plate retention slot traversing normally through the second flex arm, adjacent to the second jaw;
the first retention nub being connected to a first end of the stop plate;
the second retention nub being connected to a second end of the stop plate;
the stop plate being engaged into the first plate retention slot and the second plate retention slot; and
the first flex arm and the second flex arm being positioned in between the first retention nub and the second retention nub.

16. The safety nail clipper as claimed in claim 12, wherein the cutting slot is semicircular.

17. The safety nail clipper as claimed in claim 12 further comprises:
a casing;
the casing comprises a forward end and an open end;
the clipper assembly being positioned within the casing; and
the first jaw and the second jaw being positioned adjacent to the forward end.

18. The safety nail clipper as claimed in claim 17 further comprises:
a nail file plate; and
the nail file plate being externally mounted to the casing.

19. The safety nail clipper as claimed in claim 17 further comprises:
a grip; and
the grip being externally mounted to the casing, opposite to the push handle.

20. The safety nail clipper as claimed in claim 17 further comprises:
a cover plate; and
the cover plate being hingedly mounted to the casing, adjacent to the open end.
